(19) United States
(12) Patent Application Publication
(10) Pub. No.: US 2002/0047308 A1
(43) Pub. Date: Apr. 25, 2002

(54) Encoding/decoding system using battery voltage as keyword

(75) Inventors: Yoshikazu Saito, Shizuoka-ken (JP); Fumie Mukasa, Shizuoka-ken (JP)

Correspondence Address: Finnegan, Henderson, Farabow, Garrett & Dunner, L.L.P., 1300 I Street, N.W., Washington, DC, 20005-3315, US

(73) Assignee: YAZAKI CORPORATION.

(21) Appl. No.: 09/983,096

(22) Filed: Oct. 23, 2001

(30) Foreign Application Priority Data
Oct. 24, 2000 (JP) P 2000-324294

(51) Int. Cl. B60L 1/00; B60L 3/00; H02G 3/00

(52) U.S. Cl. 307/9.1

(57) ABSTRACT

An encoding/decoding system using a battery voltage (26) as a keyword includes transmitters (11), (12) and receivers (13), (14) on a network. Each of the transmitters and the receivers has a storage unit (35) and a keyword deriving unit (33) having a central processing unit (34) which monitors a voltage of a battery, which loads the battery voltage a plurality of times 5 minutes after the battery voltage decreases to 12 V, which calculates an average voltage from a plurality of voltage values recorded on the storage unit (35), and which records the average voltage on the storage unit (35) as keywords for the next encoding and the next decoding.

### BACKGROUND OF THE INVENTION

1. Field of the Invention

The present invention relates to a system in which keywords for encoding and decoding video data distributed onto a ring type network installed in a vehicle are derived from battery voltages.

2. Description of the Related Art

A conventional ring type network system is constituted by a data communication line installed in the form of a ring, a plurality of terminal devices connected to the data communication line, a keyword setting device for setting keywords at random, and data communication lines for distributing the keywords at random set by the keyword setting device to the respective terminal devices.

In order to prevent data from flowing out from a network, the data must be encoded and decoded by using a keyword. On the conventional network system, the keyword setting device sets keywords at random and sequentially distributes the keywords onto the data communication lines. At this time, the terminal device on the transmission side receives the distributed keyword, encodes the data, and transmits the data. The terminal device on the reception side decodes the encoded data by using the same keyword.

However, in the conventional network system, the keyword setting device for setting keywords for encoding and decoding data is independently arranged, and dedicated data communication lines for distributing the keywords to the terminal devices are provided. For this reason, the network system is expensive.

### SUMMARY OF THE INVENTION

The present invention has been made to solve the above problem, and has an object of providing an encoding/decoding system in which data can be encoded and decoded without independently arranging a keyword setting device on a network.

In this invention, a transmitter for transmitting data to the network and a receiver for receiving the data through the network are connected to the network. In a system in which the transmitter and the receiver are operated by a power of a battery the voltage of which is changed from a predetermined operation voltage to an equivalent voltage with the stop of a load, the transmitter and the receiver includes voltage detector detecting the battery voltage with an instruction of the stop of the load, and voltage loader inputting the voltage of the battery a predetermined period of time after when the voltage of the battery detected by the voltage detector is not higher than a predetermined value.

The transmitter includes keyword deriving means for calculating and storing the voltage of the battery loaded by the voltage loader of the transmitter as a keyword for encoding performed when data is transmitted after the next start, and transmission means for encoding data by the stored keyword and transmitting the encoded data while the keyword is added to the encoded data.

The receiver includes keyword deriving means for calculating and storing the voltage of the battery loaded by the voltage loader of the receiver as a keyword for decoding in reception of the next data and means which has means for, when encoded data is transmitted from the transmitter after the start of the receiver, comparing the keyword of the data with a keyword stored in the receiver itself and which decodes the data by the keyword when both the keywords coincide with each other.

The voltage loader of the transmitter and the receiver input voltages a plurality of times a predetermined period of time after the voltage detected by the voltage detection means is not higher than a predetermined voltage.

The keyword deriving means of the transmitter and the receiver calculate average values on the basis of a plurality of voltages loaded by the voltage reading means of the transmitter and the receivers. Thereafter, the average voltages are stored as keywords for the next encoding and the next decoding.

The receiver includes means for abandonment encoded data from the transmitter when the keyword of the encoded data transmitted from the transmitter through the network does not coincide with the keyword stored by the keyword deriving means of the receiver.

The network is an in-vehicle network, which is constituted such that a recording device in which video data is stored is connected to a monitor.

### BRIEF DESCRIPTION OF THE DRAWINGS

FIG. 1 is a schematic diagram of a ring type network system;

FIG. 2 is a block diagram showing the configuration of a transmitter and a receiver, which are connected to a network;

FIG. 3 is a block diagram showing further details of FIG. 2;

FIG. 4 is a graph of a change in voltage of a battery in a vehicle;

FIG. 5A is a explanatory diagram of a setting of keywords using battery voltages;

FIG. 5B is an explanatory diagram of data on a MOST network;

FIG. 6 is a flow chart showing an operation of a keyword deriving unit deriving keywords for encoding and decoding from the battery voltages; and

FIG. 7 is a flow chart showing an operation on the receiver side, which acquires a keyword from the battery voltages.

### DETAILED DESCRIPTION OF THE PREFERRED EMBODIMENT

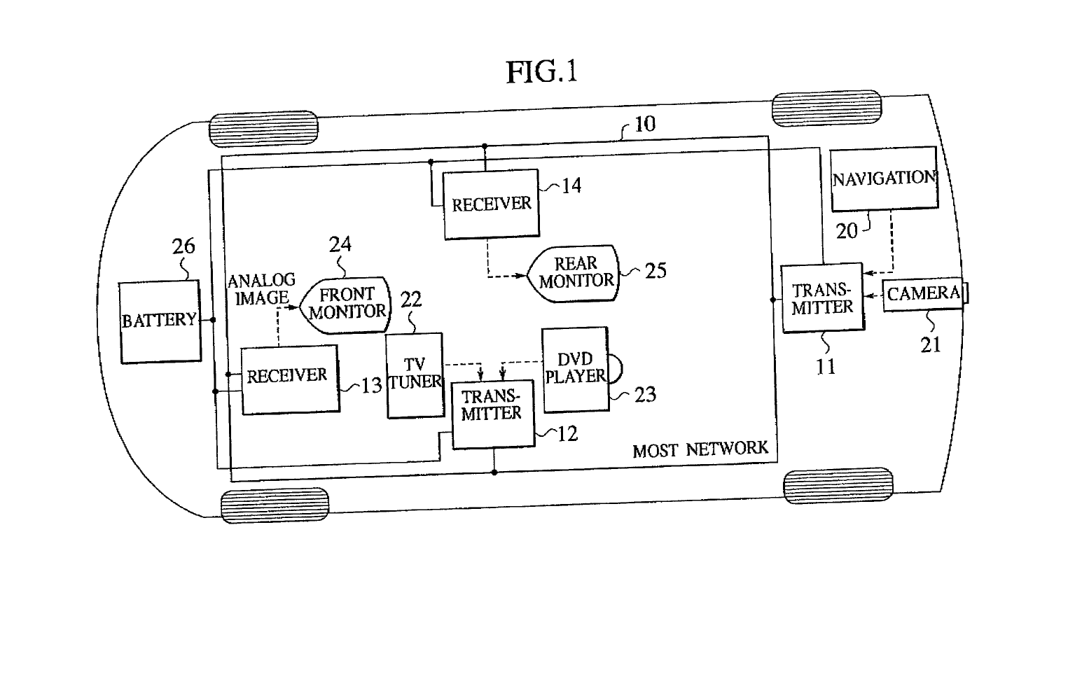

An embodiment according to the present invention will be described below with reference to the accompanying drawings. A ring type network system according to this embodiment is constituted by a MOST (Media Oriented System Transport: data transmission rate of 24.5 Mbit/sec) network 10 installed in a vehicle in the form of a ring as shown in FIG. 1, transmitters 11 and 12 and receivers 13 and 14 which are connected to the MOST network 10, and a in-vehicle battery 26 connected to the transmitters 11 and 12 and the receivers 13 and 14.

A navigation system 20 and a camera 21 are connected to the transmitter 11, and a TV tuner 22 and a DVD player 23 are connected to the transmitter 12. A front monitor 24 is connected to the receiver 13, and a rear monitor 25 is connected to the receiver 14.

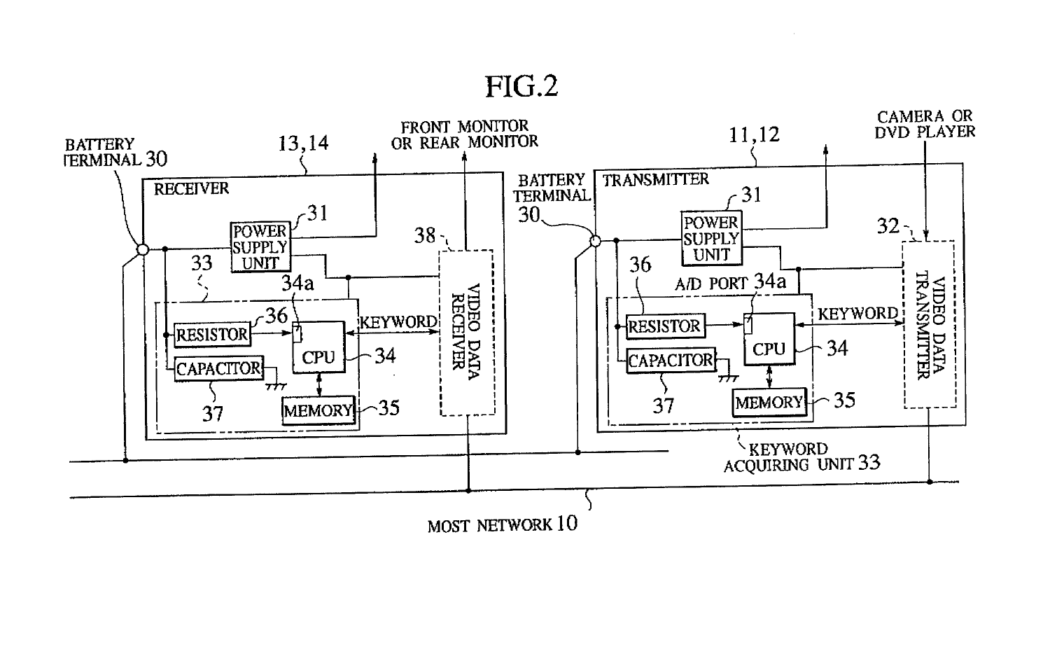

Each of the transmitters 11 and 12 comprises, as shown in FIG. 2, a power supply unit 31 for converting a battery voltage applied to a battery terminal 30 into a predetermined voltage to supply the voltage to the navigation system 20, the DVD player 23, and each component thereof, a video data transmitter 32, and a keyword deriving unit 33 according to the present invention. The video data transmitter 32 compresses video data from the camera 21 or the DVD player 23 in a compressor 32a, and encodes the compressed video data in an encoder 32b using a keyword. A synthesizer 32c combines the encoded compressed video data and the keyword, which are then distributed onto the MOST network 10.

Each of the receivers 13 and 14 comprises the same power supply unit 31 as described above, the keyword deriving unit 33 according to the present invention, and a video data receiver 38. When the video data receiver 38 receives the encoded compressed video data, the video data receiver 38 compares the keyword transmitted together with the video data with the keyword of the keyword deriving unit 33 in the video data receiver 38. When both the keywords coincide with each other, the video data receiver 38 receives the compressed video data to decode the video data, and converts the video data into an analog amount to transmit the analog amount to the monitor.

Each of the keyword deriving units 33 arranged in the transmitters 11 and 12 and the receivers 13 and 14 is constituted by a central processing unit 34, a memory 35, a resistor 36 inserted between the battery terminal 30 and an A/D port 34a of the central processing unit 34, and a capacitor 37 inserted between the battery terminal 30 and a ground 39. The resistor 36 and the capacitor 37 are parts for absorbing noise, and may be omitted if the device is not influenced by noise.

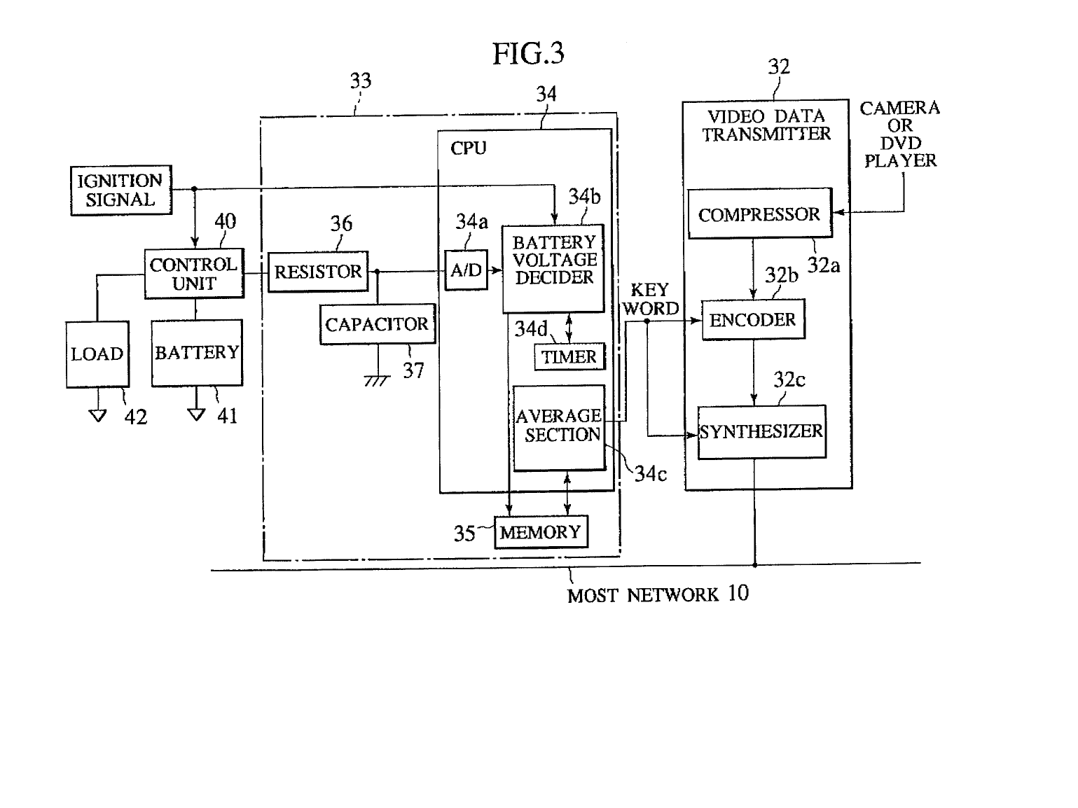

The keyword deriving unit 33 is, as shown in FIG. 3, connected to a control unit 40 for supplying power from a battery 41 to a vehicle load 42. The control unit 40 has the battery 41 supply power depending on variations of the vehicle load 42. For example, while the vehicle is running with the ignition on, power is supplied depending on variations (large load resistance) of the vehicle load 42. With the ignition off, the control unit 40 supplies small power to each component for security. The control unit 40 has a voltage detection circuit including resistors connected in parallel and series. In the voltage detection circuit with the ignition on, a large current depending on a load variation is conducted through the resistors. Thus a high voltage is detected. With the ignition off, the control unit 40 supplies small power to each given component for security in this embodiment. Thus a small current is conducted through the resistors and a small voltage is detected.

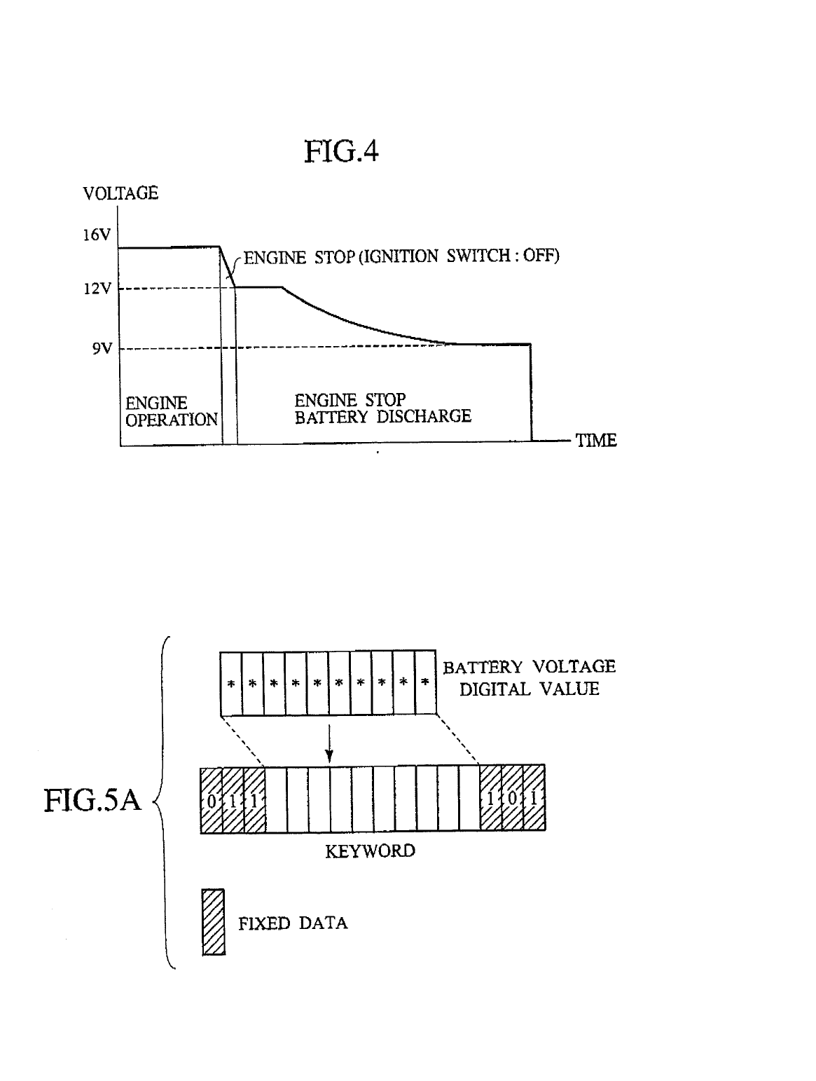

As shown in FIG. 4, the battery voltage in the engine operating state falls in the range of about 13.5 V to 16 V. When the ignition switch is turned off, the battery voltage is decreased to about 12 V through the controller 40, and then gradually decreased to about 9V (until the battery voltage reaches a stabilized balanced voltage). When an ignition signal is off, a battery voltage from the controller 40 is inputted through an A/D) converter 34a to a battery voltage decider 34b. For example, in this embodiment, a timer 34d starts counting when the battery voltage has been decreased to 12 V since the ignition switch was turned OFF. At the count of five minutes, the battery voltage is loaded. A stabilized battery voltage, i.e., a voltage of the level of 9 V is loaded. Such a battery voltage is repeatedly loaded, e.g., five times to record the battery voltage on the memory 35.

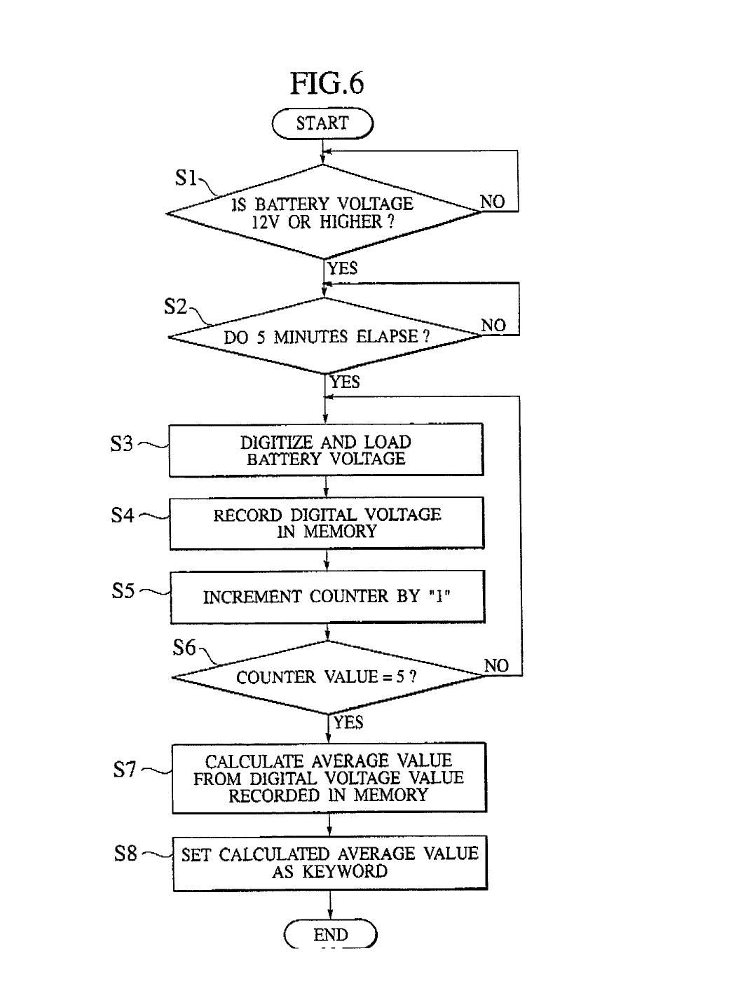

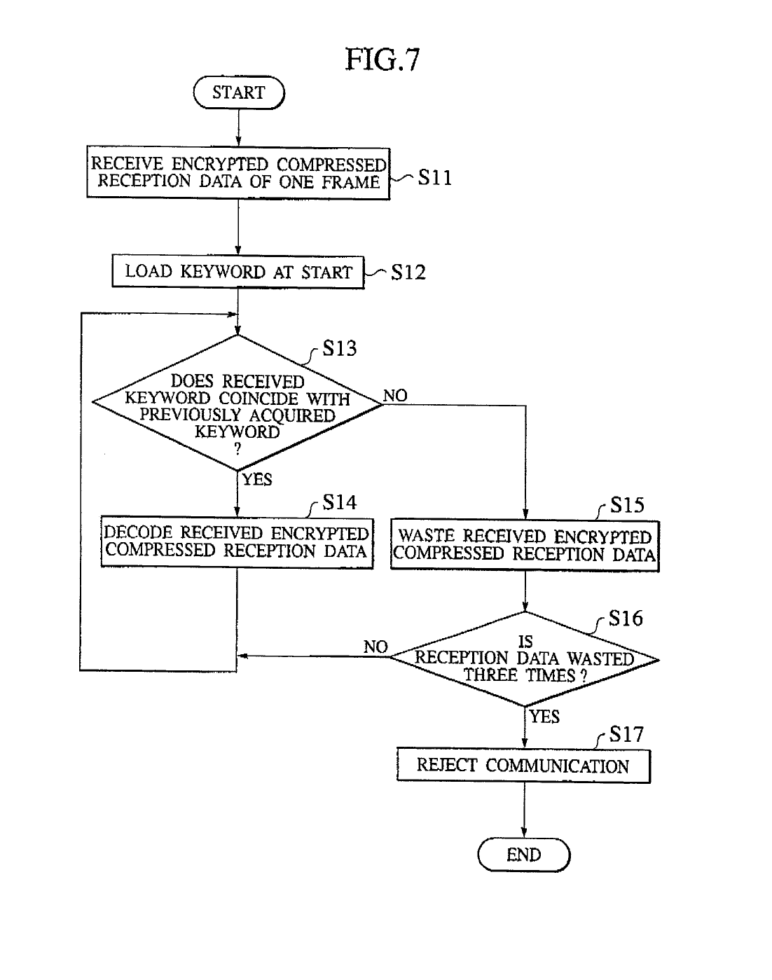

In the ring type network system constituted as described above, the operation of the keyword deriving unit for deriving keywords for encoding and decoding from a battery voltage will be described below with reference to the flow chart shown in FIG. 6. It is assumed that the engine of the vehicle is operated.

At this time, an ignition signal is inputted to the battery voltage decider 34b of the central processing unit 34 of each of the keywords deriving units 33 arranged in the transmitters 11 and 12 and the receivers 13 and 14, to determine whether the engine is on/off. Then the battery voltage decider 34b determines whether the battery voltage is not more than 12 V (S1). When the switch is off and the battery voltage is not more than 12V, time count is started. It is determined whether five minutes have elapsed (S2). When 5 minutes have not yet elapsed, time counting is continued. When 5 minutes have been elapsed, a battery voltage applied to the A/D port 34a is digitized to load (S3) and is recorded on the memory 35 (S4). The counter is incremented by “1” (S5), and it is determined whether the counter value reaches “5” (S6).

Since the counter value is “1” at this time, the battery voltage is again digitized to load (S3) and recorded on the memory 35 (S4). The counter is further incremented by “1” and it is determined whether the counter value reaches “5” (S5, S6) in the same manner. When the counter value is not “5”, the above operation (S3 to S6) is repeated. When the counter value reaches “5” by repeating the operation, an averaging situation 34c calculates an average voltage from the five voltage values recorded on the memory 35 (S7). The average voltage is recorded as the keywords for the next encoding and the next decoding on the memory 35 (S8), and the series of operations is ended.

The keywords obtained by the series of operations held by the keyword deriving units 33 arranged in the two transmitters 11 and 12 and the two receivers 13 and 14 which are connected to the MOST network 10.

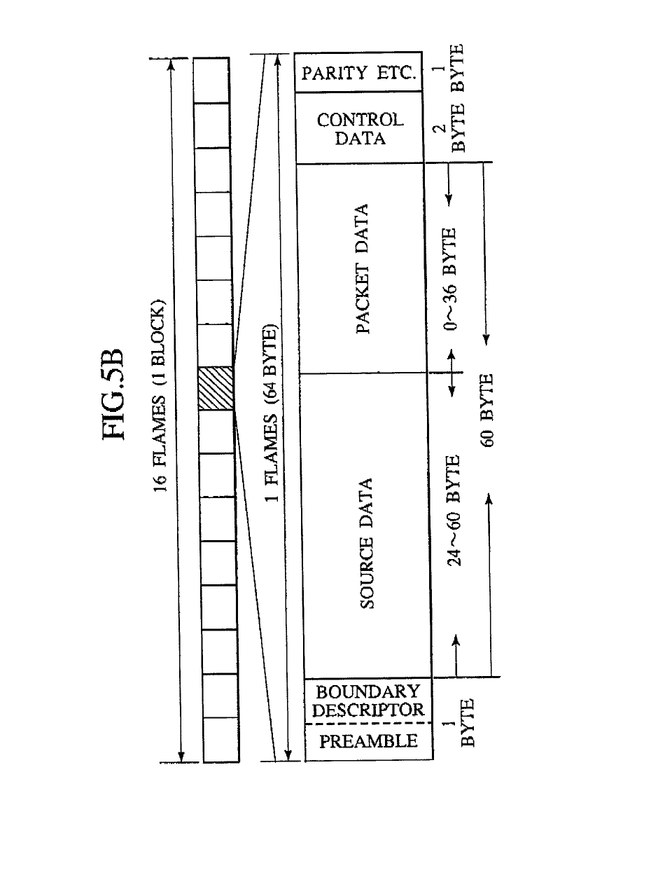

Here, for example, it is assumed that the engine of the vehicle is driven by turning on the ignition switch and that video data is transmitted from the DVD player 23. A compressor 32a of the video data transmitter 32 of the transmitter 12 compresses video data for every frame. An encoder 32b loads the keyword derived in advance, from the keyword deriving unit 33, and converts the compressed video data into a byte length represented by the keyword to encode the video data. Now with reference to FIG. 5B, description is given to details of data distributed on the MOST network. The MOST network for use in the present invention limits data capacity per frame to sixty bytes. The sixty bytes are allocated to data compressed in compliance with MPEG-2, for example. Changing the setting of MOST allows either using all of the sixty bytes for compressed data to be transmitted or using some of the sixty bytes for the same purpose. A control data portion shown in the figure contains the keyword. In FIG. 5A, fixed data is added to the keyword. The fixed data may include fixed data for identifying the initial and final of the keyword. The remaining four bytes include data such as parity and a preamble. The keyword and the compressed encoded data are synthesized in a synthesizer 32c for transmission to the MOST network (an interface with the MOST network is not shown in FIG. 3).

The operation on the receiver which derives the keyword from the battery voltage will be described below with reference to the flow chart shown in FIG. 6.

For example, when encoded compressed video data is received by the receiver 14 which requests a video image of the DVD player 23 to be received, the video data reception unit 38 of the receiver 14 receives encoded compressed video data of one frame and loads a keyword which is at the head and which is derived by a keyword deriving means in the transmitter (S1 and S12). In the same step as the step in which the keyword is derived in the transmitter in advance, a keyword stored in the memory 35 is loaded from the keyword deriving unit 33. Both the keywords are compared with each other to check whether both the keywords coincide with each other (S13). When both the keywords coincide with each other, the receiver 14 intakes the received encoded compressed video data to decode the video data by the keyword (S14), and converts the video data into an analog amount to transmit the analog amount to the rear monitor 25. Returning to S11, the above operation is repeated.

On the other hand, when both the keywords do not coincide with each other, the received encoded compressed video data is abandoned (S15). It is decided whether the abandonment is repeated three times (S16). When the abandonment is not repeated three times, the control flow returns to step S11 to repeat the above operation. When the received data is abandoned three times, communication is rejected (S17), and the receiving operation is ended. The keyword deriving unit 33 of each receiver has essentially the same architecture as that of the transmitters as shown in FIG. 3, but additionally includes a data abandoning section and a keyword comparing section not shown in the CPU 34.

As described above, in this embodiment, when the ignition switch is turned off, a battery voltage is loaded five times five minutes after to calculate an average voltage. The keyword deriving unit 33 which records this average voltage on the memory 35 as keywords for the next encoding and the next decoding is arranged in each of the transmitters 11 and 12 and the receivers 13 and 14 on the MOST network 10. For this reason, unlike the related art, a keyword setting device 3 is not necessarily arranged on the network. In addition, a data communication line 4 for distributing keywords to respective terminal devices 2 is not necessarily installed. Therefore, an inexpensive network system can be structured.

In the above embodiment, the battery voltage is loaded five times to calculate an average value, and the average value is set as keywords for the next encoding and the next decoding. However, the battery voltage may be loaded five or more times, and the battery voltage may be loaded once to be used as a keyword.

The network system according to this embodiment is applied to a vehicle in the above description. However, the network according to this embodiment can be applied to an airplane, a ship, or the like, as a matter of course. In addition, the battery described above is desirably constituted by a plurality of lead batteries.

What is claimed is:

1. A system encoding/decoding data in which a transmitter transmitting data to a network and a receiver receiving the data through the network are connected to each other, and the transmitter and the receiver are operated by a power of a battery the voltage of which is changed from a predetermined operation voltage to an equivalent voltage with the stop of a load, comprising:
a voltage detector detecting the voltage of the battery with an instruction of the stop of the load; and
a voltage loader inputting the voltage of the battery a predetermined period of time after when the voltage of the battery detected by the voltage detector is not higher than a predetermined value, the voltage detector and the voltage loader constituting the transmitter and the receiver, wherein
the transmitter having a keyword deriving unit calculating and storing the voltage of the battery loaded by the voltage loader of the transmitter as a keyword for encoding when the next data is transmitted, and an encoder encoding data by the stored keyword and adding the keyword to the encoded data to transmit the data, and
the receiver having a keyword deriving unit storing the voltage of the battery loaded by the voltage loader of the receiver as a keyword for decoding in reception of the next data, and a decoder decoding the encoded data using the keyword when the data is received from the transmitter and when the keyword of the encoded data coincides with the keyword stored by the keyword deriving unit of the receiver.

2. A system, operated by a power of a battery, for encoding/decoding data according to claim 1, wherein
the voltage loader of the transmitter and the receiver input voltages a plurality of times a predetermined period of time after when the voltage detected by the voltage detector is not higher than a predetermined value, and
the keyword deriving unit of the transmitter and the receiver calculate average values on the basis of a plurality of voltages loaded by the voltage loader of the transmitter and the receiver, and stores the average voltages as keywords for the next encoding and the next decoding.

3. A system, operated by a power of a battery, for encoding/decoding data according to claim 1, wherein
the receiver has means for abandonment encoded data from the transmitter when the keyword of encoded data transmitted from the transmitter through the network does not coincide with a keyword stored in the keyword deriving unit of the receiver.

4. A system, operated by a power of a battery, for encoding/decoding data according to claim 1, wherein
the network is an in-vehicle network which is constituted such that a recording device in which video data is stored is connected to a monitor.

5. A system, operated by a power of a battery, for encoding/decoding data according to claim 1, wherein the network is a MOST network.

6. A system operated by a power of a battery, for encoding/decoding data according to claim 1, wherein the receiver has means for comparing the keyword of encoded data transmitted from the transmitter through the network with a keyword stored in the keyword deriving unit of the receiver to check whether both the keywords coincide with each other or not.

7. A system operated by a power of a battery, for encoding/decoding data according to claim 2, wherein the transmitter and the receiver having a detector detecting the predetermined period of time.

8. A system for encoding/decoding data in which a transmitter transmitting data to a network and a receiver receiving the data through the network are connected to each other, and the transmitter and the receiver are operated by a power of a battery the voltage of which is changed from a predetermined operation voltage to an equivalent voltage with the stop of a load, comprising steps of:
monitoring the voltage of the battery;
measuring a predetermined period of time after the voltage of the battery is changed into a predetermined voltage;
loading the voltage of the battery after the predetermined period of time elapses;
deriving a keyword from the loaded voltage of the battery;
encoding data by using the keyword to transmit the encoded data;
receiving the data transmitted by the keyword;
comparing the keyword of the received data with a keyword in the receiver; and
decoding the received data when the two keywords coincide with each other.

9. A system, operated by a power of a battery, for encoding/decoding data according to claim 8, wherein
the keyword is calculated from an average value of the voltages of the battery.

10. A transmitter, operated by a battery connected to a network transmitting data by using a keyword, comprising:
a voltage loader loading a voltage of the battery;
a keyword deriving unit calculating and storing the voltage of the battery loaded by the voltage loader as a keyword for encoding when data is transmitted to the network; and
a transmitter encoding the data by using the keyword and transmitting the encoded data while the keyword is added to the data.

11. A receiver, operated by a battery connected to a network receiving data encoded by using a keyword, comprising:
a voltage loader loading a voltage of the battery;
a keyword deriving unit calculating and storing the voltage of the battery loaded by the voltage loader as a keyword for decoding when data is received by the network;
and a decoder decoding the encoded data using keyword when the data is transmitted from a transmitter, and when the keyword of the encoded data coincides with a keyword stored in the keyword deriving unit of the receiver, decoding the data by the keyword.
